(19) United States
(12) Patent Application Publication
(10) Pub. No.: US 2015/0350295 A1
(43) Pub. Date: Dec. 3, 2015

(54) System And Method For Loading Assets During Remote Execution

(71) Applicant: Joel Solomon Isaacson, Rehovot (IL)

(72) Inventor: Joel Solomon Isaacson, Rehovot (IL)

(21) Appl. No.: 14/288,764

(22) Filed: May 28, 2014

(51) Int. Cl. H04L 29/08; H04L 29/06

(52) U.S. Cl. CPC H04L 67/025; H04L 67/10; H04L 67/42

(57) ABSTRACT

This invention generally relates to remote execution of computer applications. More specifically to a system and method of managing the transmission of assets needed for remote execution. The techniques described are particularly suited to graphical programs but have a wider domain of application.

### CROSS REFERENCE TO OTHER APPLICATIONS

This application claims priority to U.S. Provisional Patent Application No. 61/828,112 entitled Cloud Graphical Rendering filed May 28 2013 which is incorporated herein by reference for all purposes.

### FIELD OF THE INVENTION

This invention generally relates to remote execution of computer applications. More specifically, it relates to a system and method of managing the transmission of assets needed for remote execution. The techniques described are particularly suited to graphical programs but have a wider domain of application.

### BACKGROUND

Remote execution of computer applications has a long history. It is sometimes referred to as “client-server computing.” More recently, the term “cloud computing” is commonly used and it has become a major focus of today's computer industry. Cloud computing, commonly referred to as “the cloud”, provides computational resources via a computer network. In the traditional model of computing, both data and software are fully contained on a user's computer. In a cloud computing configuration, however, the user's computer may contain relatively little software or data relating to the application but rather may serve as a display terminal for processes occurring within a network of computers. Cloud computing is a cost effective means of delivering information technology services through a virtual platform rather than hosting and operating the resources locally.

There is another powerful trend that is orthogonal to the concept of cloud computing. This is the increasing usage of personal mobile devices. In this computing model, the computing device is in close proximity to the person using it, and the applications are installed and run on that device. Applications generally have a graphical interface. The responsiveness and graphical performance of modern personal mobile devices are high, displaying a large number of frames per second (fps). Generally, applications are expected to render 60 frames per second without any misses or stalls.

One way of combining cloud computing with personal mobile devices is to run the application in the cloud and export the graphics via a remote graphics protocol. The challenge of providing high quality graphics over a low bandwidth link is not trivial.

### Remote Graphic Systems

Remote graphics systems have a long history and are widely used. One of the earliest, the X window system, usually abbreviated X11, was introduced in 1984 and is in common use today. Unlike most earlier display protocols, X11 was designed to separate the graphics stack into two processes that communicate via IPC (Inter Process Communications). The X11 protocol is designed to be used over a network between different operating systems, machine architectures and a wide array of graphic display hardware. X11's network protocol is based on the original 2-D X11 command primitives and the more recently added OpenGL 3D primitives for high performance 3-D graphics. This allows both 2-D and 3-D operations to be fully accelerated on the X11 display hardware.

Another widely used remote graphics protocol is the Remote Desktop Protocol (RDP), a proprietary protocol developed by Microsoft, which provides users with a graphical interface to another computer. This system provides remote access to more than just graphics. Clients exist for most versions of Microsoft Windows (including WINDOWS Mobile), Linux, Unix, Mac OS X, Android™, and other modern operating systems.

There are many other examples of proprietary client-server remote desktop software products including Oracle/Sun Microsystems' Appliance Link Protocol, Citrix's Independent Computing Architecture and Hewlett-Packard's Remote Graphics Software.

All of the above remote graphics systems were carefully designed to allow remote access to graphic applications. There are some systems that can be used to retrofit remote capabilities in systems that have not been specifically designed for remote graphics such as Virtual Network Computing (VNC).

Many graphics stacks are designed with the assumption that all the elements of the stack reside on one device. It is sometimes advantageous to distribute the graphics stack between more than one device. In order to distribute the graphic rendering, network communications must be established between pixel rendering elements of the graphic rendering stack residing on different machines. Isaacson (U.S. Patent Application No. 2012/0113091 A1) deals with retrofitting graphics stacks that were not designed for remote operation to work efficiently with the graphics stack split between machines.

There are many remote graphics systems that work on the pixel level. Typically on modern systems, graphic frames are encoded with a video codec (e.g. H.264, V9 or VNC) and transmitted via a network stream. There are no assets which are constructs of the rendering level. Assets such as textures are effectively repeatably transferred as they go in and out of view.

### Remote Graphical Rendering and Assets

There are many rendering systems for which assets can be naturally identified. The Android™ system has many rendering interfaces that are good targets for the described techniques for asset loading and remote rendering. The Android™ software pixel renderer is the SKIA renderer. The Android™ hardware pixel renderer is OpenGL based. There are other rendering systems available that are more advantageous for efficient rendering. The Android™ Canvas.cpp interface is a higher level C++ interface that generates SKIA graphic rendering calls. The Android™ OpenGLRenderer.cpp interface is a higher level C++ interface that generates OpenGL graphic rendering calls. Both of these C++ interfaces, from the AOSP (Android Open Source Project), are good targets for the described techniques for both asset loading and remote rendering. The WebView widget is also a high level rendering interface that might generate SKIA or OpenGL graphic rendering calls. Both remote rendering and asset identification are applicable to the WebView widget. Other modern graphical systems such as Microsoft Windows (including WINDOWS Mobile), Linux, Apple OS X and Apple IOS use rendering systems that can also benefit from the techniques of the present invention.

The system software overview is shown in FIG. 2. Here the graphics stack of FIG. 2 has been modified in order to allow rendering to be distributed between two separate devices. The lefthand side of the figure shows the standard graphics stack of a mobile device 209 that will be referred to as the remote device. The right hand side of the figure shows the truncated graphics stack 210 that will be referred to as the local device.

The user application 201 uses the API of the Graphical Toolkit 202. The Graphical Toolkit 202 uses the API of the Graphical Renderer 203. The arrow 212 indicates the interaction between the user application 201 and the Graphical Toolkit 202. The arrow 213 indicates the interaction between the Graphical Toolkit 202 and the Graphical Renderer 203. The arrow 214 indicates the interaction between the Graphical Renderer 203 and the Surface Composer 204. The stack 209 has been modified, from the local application stack, to forward requests from the Graphic Renderer 203, via an extension stub 205, which sends graphical rendering requests via a network connection 211, to an extension stub 206, that relays graphical rendering requests to a Graphic Renderer 207 on the local device to render the actual pixels on a buffer. The truncated graphics stack 210 will render 207 and via 215 compose 208 the graphical image on the local device. In some embodiments, the Surface Composer 208 is absent and the Graphical Renderer 207 renders on the graphical display directly not on an intermediate pixel buffer. In other embodiments, the user application 201 and the Graphical Toolkit 202 might be merged into one entity or expanded into more than two entities.

The extension stub 205 takes a sequence of rendering commands and assembles them into a serial data stream suitable for transmission via the network link 211 and transmits this data stream. The extension stub 206 receives the serial data stream and disassembles it into a sequence of rendering commands suitable for the Graphic Renderer 207.

The Graphic Renderer 203 does not normally pass requests to the Surface Composer 204, via 214, since graphical output at the remote device is not normally required at the remote location. This lessens the computation load on the remote device.

The stream of graphical rendering 211 transfers information in one direction only. This simplex transfer pattern prevents network round-trip latency from slowing down graphical performance. The volume of data passing through the rendering stream 211 is greatly compressed with suitable techniques.

### SUMMARY OF THE INVENTION

Computer applications frequently have a large number of assets that are needed for execution. Typically assets referenced by the application might be bitmaps, textures, vertices, video clips or audio clips.

Bitmaps, textures, and vertices are objects that are referenced by rendering API's repeatably and can be quite large. For many rendering systems, bitmaps are used. For OpenGL, textures and vertices are used. These elements are sent once and typically referenced many times. Care should be taken that these objects are sent only once and are cached for subsequent references.

If these objects are not available when referenced, there might be a delay (i.e. a stall) of the frame while the object is being loaded. It is therefore important to schedule the preloading of objects before they are referenced. If the cloud server repeatedly runs an application, a statistical model of object usage can be developed. This probabilistic graphical model allows highly accurate preloading of objects with a low probability of rendering stalls due to data dependencies.

Typically assets are used many times during the application's execution. The use of interest for the “Asset Use Data Base” (108, FIG. 1) is the first asset use. Accordingly the term “asset use” will be understood to be the “first asset use”. The first asset use will cause the stall in the application. Subsequent uses will not cause a stall if the asset is loaded after the first stall.

### BRIEF DESCRIPTION OF THE DRAWINGS

FIG. 1 shows the remote and local rendering software with the local side having a partial set of assets.

FIG. 2 is a typical graphic stack modified for remote operation for a digital device that is in the prior art.

FIG. 3 is a simplified diagram of the hardware comprising a system for remote graphics that loads assets based on predicted asset usage patterns

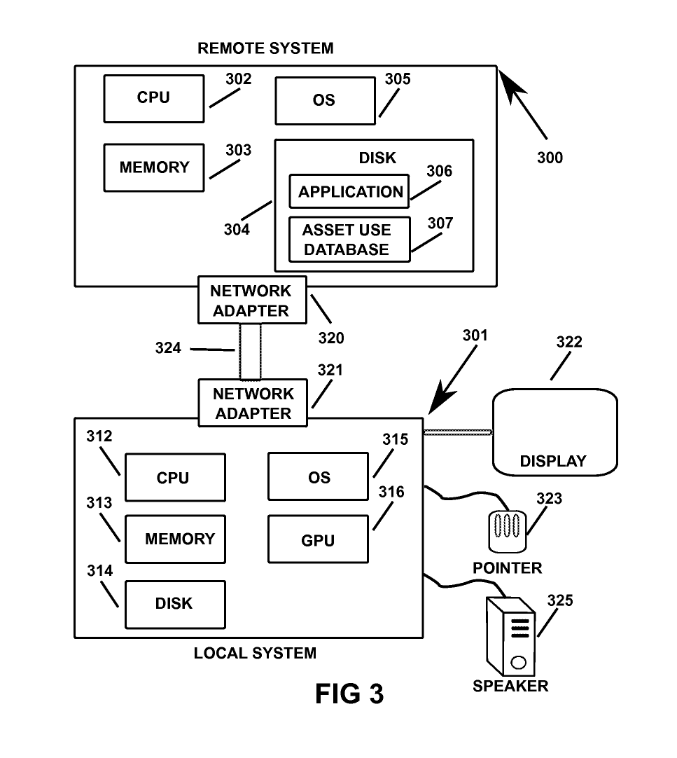

### BRIEF DESCRIPTION OF THE TABLES

TABLE 1 shows the remote protocol transfer of a graphical application running remotely with two network channels. Channel 1 transmits the rendering commands while channel 2 transmits the bitmap assets.

TABLE 2 shows the asset use pattern for 16 application executions.

TABLE 3 shows the calculated dependent probabilities P(i|l) for the 16 application executions of TABLE 2.

TABLE 4 shows the calculated most probable asset use sequence and probabilities for the dependent probabilities P(i|l) of TABLE 3 and equation 2, given the last actual used asset is 1.

TABLE 5 shows the calculated most probable asset use sequence and probabilities for the dependent probabilities P(i|l) of TABLE 3 and equation 2, given the last actual used asset is 18.

TABLE 6 shows the calculated most probable asset use sequence and probabilities for the dependent probabilities P(i|l) of TABLE 3 and equation 2, given the last actual used asset is 19.

TABLE 7 shows the calculated most probable asset use sequences for all last actual used assets.

### BRIEF DESCRIPTION OF THE LISTINGS

LISTING 1 shows a C program that will calculate from a data base of asset use patterns, the most probable asset load sequence given the last asset loaded.

### DETAILED DESCRIPTION OF THE INVENTION

### System Hardware and Operating Software

In this description of the computer hardware only items of relevance are noted. The systems os comprised of two systems connected via communication channel 324. The remote system 300 typically does not have a human interface, but might be located in what is colloquially called, the “Cloud”. The remote CPU 302 is needed to run the application and manage the hardware resources. The memory 303 is used to store the executing programs and data. The disk 304 will store persistent program images and data. The operating system (OS) 305 provides the infrastructure that will allow user programs to access system resources. The network adapter 320 will allow the remote system to communicate with systems that are connected via a common network. The computer network 324 might be an isolated LAN (local area network) or might give connectivity to the global Internet. The disk 304 contains an executable program image 306 and the asset use database 307 tied to a particular application.

The local system 301 has means for user interaction and a network adapter 321. The display 322 will allow graphics to be shown. There will usually be some type of human interaction available (mouse, touch screen, keyboard) 323. Audio output is played through the speaker 325. The local system contains a CPU 312, memory 313, disk 314 and OS 315 as was noted in the remote system. In addition the GPU (Graphics Processing Unit) 316 is useful for rendering graphics on the local display 322. There might be a GPU on the remote system but typically it will not be needed.

### System Overview

### Asset Use and Reference

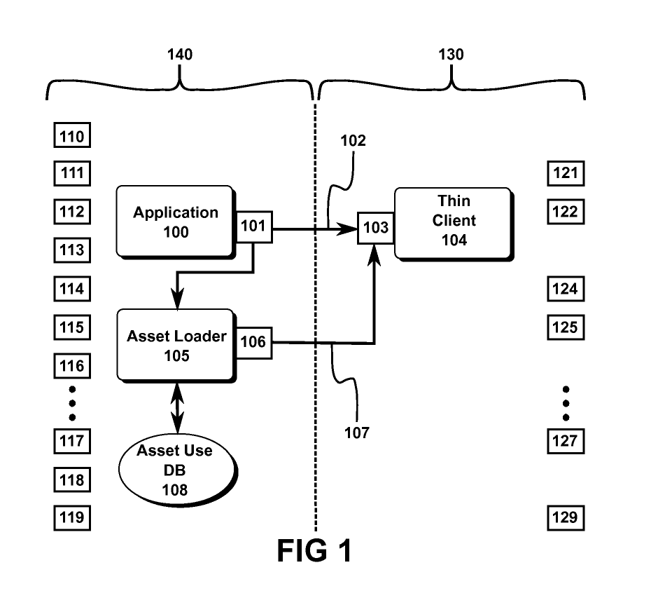

FIG. 1 shows a server-client system with assets on both the remote and local sides. Here the remote system is the left side denoted by 140. The local system is the right side denoted by 130. The remote application 100 has been modified to include an extension stub 101 to transmit the command stream on the communication link 102 and to report asset usage to the asset loader 105. The asset loader 105 receives the asset usage reports and accesses the asset usage historical data base 108 to calculate the assets to preload which are transmitted via the transmitter 106 and communication link 107. The local thin client 104 has a receiver 103 connected to the communication links 102 and 107 to receive the transmitted command and asset streams. The communication links 102 and 107 are normally multiplexed onto one physical communications channel which is demultiplexed by the receiver 103. The assets on the remote side are shown as 110-119. The corresponding assets on the local side have 10 added to the remote asset number. The assets loaded on the local system are
{121,122,124,125,127,129}.
   The assets that have yet to be loaded are
{120,123,126,128}.

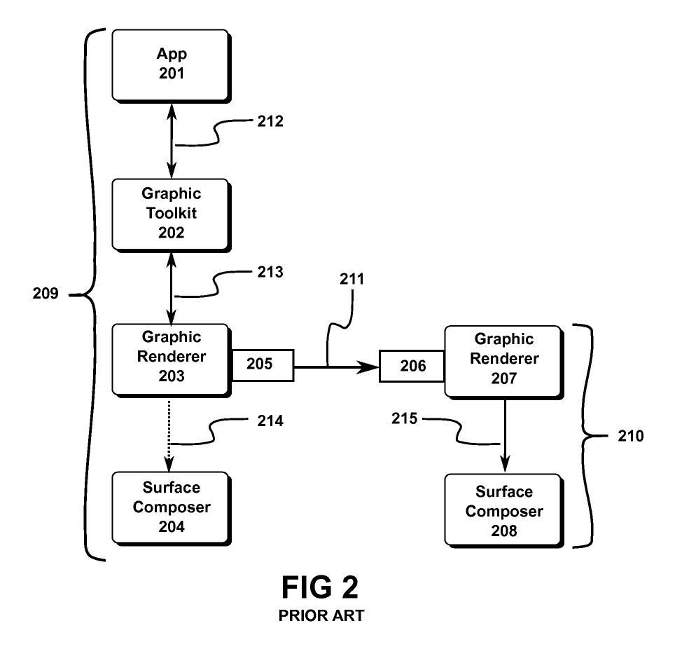

The graphical application of FIG. 2 maps naturally to the present invention of FIG. 1. The application elements 201, 212, 202, 213, 203, 214, 204 of FIG. 2, map to the application 100 of FIG. 1. The extension stub 205 of FIG. 2 maps to the extension stub 101 of FIG. 1. The communication link 211 of FIG. 2 maps to the communication link 102 of FIG. 1. The receiver 103 of FIG. 1 maps to the extension stub 206 of FIG. 2. The graphical renderer 207 and composer 208 of FIG. 2 map to the thin client 104 of FIG. 1.

In the described remote rendering system, an application in binary form is obtained and is run on the remote host. There is no prior knowledge of the assets needed to successfully run the application. As the application is run on the remote host the assets are transferred to the local system before use. The remote rendering stream can be captured and analyzed. The simplest technique for loading assets is to take one run of the application and to assume that the subsequent runs of the application will have an asset use pattern which is largely similar to the traced run. The application can be run once, assets extracted and the asset access order recorded.

A simple example might contain the SKIA command to draw a bitmap:
virtual void drawBitmapRect (const SkBitmap &bitmap, . . . );

We will schematically represent the drawBitmapRect( ) command for bitmap asset Bᵢ as D(Bᵢ). We will represent other commands that do not assess a bitmap asset, as Oⱼ. A typical run of the application might have a sequence such as:
O₁D(B₁)O₂D(B₂)O₃D(B₁)O₄O₅D(B₃)O₆D(B₁)O₇.
   In this sequence three bitmap assets are used: {B₁, B₂, B₃}. Without loss of generality we can separate the drawBitmapRect( ) command into a load-use pair of functions:
D(Bᵢ)=L(Bᵢ)U(Bᵢ).
   The L(Bᵢ) function will transfer the bitmap, Bᵢ, from the remote to the local system. The U(Bᵢ) function will draw the previously transferred bitmap, Bᵢ, on the local image buffer and is identified with the asset Bᵢ's use. The previous sequence of remote rendering commands is then:
O₁L(B₁)U(B₁)O₂L(B₂)U(B₂)O₃L(B₁)U(B₁)O₄O₅L(B₃)U(B₃)O₆L(B₁)U(B₁)O₇.
   This sequence can be optimized under the assumption that the transferred bitmaps are stored in a cache after their first use and remain available for rendering:
O₁L(B₁)U(B₁)O₂L(B₂)U(B₂)O₃U(B₁)O₄O₅L(B₃)U(B₃)O₆U(B₁)O₇.
   In this sequence bitmap, B₁, is transferred once and used three times, saving two network transfers of B₁.

Any ordering of the remote rendering commands that preserve the order of the Oⱼ and U(Bᵢ) commands and precede a L(Bᵢ) command before the first U(Bᵢ) command will render identically. One policy could be to send the assets before the application begins execution:

L(B₁)L(B₂)L(B₃)O₁U(B₁)O₂U(B₂)O₃U(B₁)O₄O₅U(B₃)O₆U(B₁)O₇.

This allows the rendering to precede without any stalls due to unavailable bitmaps. This policy however, might not be optimal since the application will have to wait for all assets to load before beginning and possibly cause a large startup latency. This strategy can be used to preload assets on subsequent executions of the application, with the expectation that the preloaded assets accurately represent the asset use of subsequent application invocations.

Since the asset use pattern might change with time, a more accurate asset use estimate might be to take the asset use traces of the most recent application invocations as a more accurate pattern of asset use.

There are more efficient ways to load assets that will allow the application to start faster and not suffer any asset related stalls. TABLE 1 shows transmission of the rendering stream. In this table the transmission of the rendering stream has two independent channels (the two rows of the table). The first channel is used for the rendering commands and corresponds to 102 FIG. 1. The second channel is used for loading assets and corresponds to 107 FIG. 1. By using two channels working in parallel, loading large assets are kept from causing rendering stalls. The latency for beginning execution of the application is one transmission time slot due to the stall induced by asset B₁.

TABLE 1 shows how loading the bitmap assets can overlap the rendering. The bitmaps have to load before they are used. In this example, the time to load the first and second bitmaps takes two transmission slots. The third bitmap takes three slots to transmit. The first bitmap, B₁, must precede the first rendering command, O₁, by one transmission slot so as not to cause a stall. This results in a one transmission slot latency in application startup.

The asset use traces should be used in conjunction with the actual asset use of the currently running application. An example would be: The application trace of a previously run application has an asset load sequence of
{1,2,3,4,5,6,7,8,9,22, 10,11,12,13,14,15,16,17,18,19,20,21}.
   The assets
{1,2,3,4,5,6,7,8}
   have been loaded. If the next asset used by the currently running application is 14, creating a stall, the asset load sequence should continue with
{4,15,16,17,18,19,20,21}.

There is an alternative to stalling when an asset is not available. A “placeholder” for the asset can be used. In the case of a missing bitmap, a blank or crosshatched bitmap can be inserted until the bitmap is available. This is the accepted practice in web browsers. When a web page is loaded the text is rendered and the bitmaps are rendered incrementally as they arrive. If the missing asset is a video or audio clip, the playing of the clip could be simply delayed until it arrives while all other activities, such as rendering, can continue unaffected.

### Asset Prediction

A common case is applications that are repeatably run on cloud servers. Due to statistical predictability of applications, it is frequently possible to predict and preload the assets to reduce stalls and latency. Statistics on the asset's usage can be acquired each time the application is run. As the number of runs increases, an accurate statistical model is built up.

A simple strategy is based on the conditional probability of first asset uses. A more sophisticated asset loading strategy would take into account the size of the asset (i.e. the time to load the asset), the times when the assets were first used, and other relevant parameters.

We denote the assets of an application as
{a,b,c,d,e, . . . ,x,y,z}.
   Greek symbols will be used for asset variables. We can introduce the conditional probability, P(θ|c,b,a . . . ), the probability of θ given the first uses of assets . . . a,b,c have last occurred. For example: if the assets a,b,c have just been just used, in this order, we can search for the maximum probability P(θ|c,b,a . . . ) for θ given the last events { . . . ,a,b,c}. Once the asset θ is loaded, it is added to cache [symbol] . A search for σ in the new probability space

P′(σ|c,b,a, . . . )=P(σ|c,b,a, . . . )+P(σ|θ,c,b,a, . . . )P(θ|c,b,a . . . ) σ≠θ

P′(σ|c,b,a . . . )=0 σ=θ (1)

for the maximum probability for σ∉ [symbol] gives the next element to load. This procedure is repeated multiple times to preload the most probable elements given the last assets that were actually used. This procedure will make “asset stalls” a rare occurrence.

When the next, hopefully preloaded, element f is actually used in rendering, the search space will collapse to the conditional probability, P(θ|f, c,b,a . . . ) for θ, since we now have knowledge on the actual elements used and can calculate probabilities based on usage from that state.

The C program of LISTING 1 will calculate the most probable assets that will be used given a data base of usage. The data base for this example is given in TABLE 2. It is loaded into the array u by the read_asset_use( ) routine in line 36 of LISTING 1. The definition of the read_asset_use( ) routine does not appear in LISTING 1. The dependent probability P(i|l) is calculated in routine calculate_probability( ) at line 37 of LISTING 1 and for the example data base is shown in TABLE 3. The sequence of probable asset use is calculated in the load_order( ) routine. The equation for propagating the most probable asset used differs from equation 1 and is

P′(σ|c,b,a, . . . )=P(σ|c,b,a, . . . )+P(σ|θ,c,b,a, . . . )P(θ|c,b,a . . . ) σ∉

[symbol]

P′(σ|c,b,a . . . )=0 σ∈C (2)

as shown on line 114-115 of LISTING 1. Equation 1 preserves the total conditional probability to be always 1, while equation 2 prunes loops to previously loaded assets and is generally less than or equal to 1. The use of either equation 1 or 2 predicts similar asset load sequences and either are arguably reasonable.

TABLE 4 shows the sequence of loaded assets assuming that the last loaded asset was 1. In this case, the asset load sequence is:
{1,2,3,4,5,6,7,8,9,22,10,11,12,13,14,15,16,17,18,19,20,21}.
   Note that the asset 22 comes between the assets 9 and 10. Each row in the table has the probability for each asset to be used. In each row the asset with the maximum probability is chosen as the next asset to load and it appears in column 1 of the table.

TABLE 5 shows the sequence of loaded assets assuming that the last loaded asset was 18. In this case, the asset load sequence is:
{18, 19, 20, 21, 14, 15, 16, 17, 7, 8, 12, 13, 9, 22, 10, 11}.

TABLE 6 shows the sequence of loaded assets assuming that the last loaded asset was 19. In this case, the asset load sequence is:
{19,20,21}.

TABLE 7 shows the most probable sequence of used assets given the last loaded asset.

### Render Stream Asset Mapping

There are objects in the renderers API that are valid at the remote renderer but have no valid meaning in the local end. A simple example is a bitmap in the Skia renderer. The bitmap's handle is a pointer that is valid on the remote machine. It is not valid on the local machine.

In order to reference a bitmap on the remote machine its value (pixels) must be transferred to the local machine and a local mapping associated with bitmap. Thereafter when a reference to the bitmap is used, the remote-local mapping is used to resolve it. If the bitmap that is associated with the remote pointer is not invariant then a cryptographic checksum, which is only dependent on the bitmap value, can be used.

Some typical objects that need mapping are:

Shader objects

Shader attribute bindings

Texture bindings

Buffer objects

Vertex arrays

Audio clips

Video clips

TABLE 1

| | Transmission Slots | | | | | | | | | | | | |
|---|---|---|---|---|---|---|---|---|---|---|---|---|---|
| | 1 | 2 | 3 | 4 | 5 | 6 | 7 | 8 | 9 | 10 | 11 | 12 | 13 |
| 1 | | O₁ | U (B₁) | O₂ | U (B₂) | O₃ | U (B₁) | O₄ | O₅ | U (B₃) | O₆ | U (B₁) | O₇ |

| | | | |
|---|---|---|---|
| 2 | L(B₁) | L(B₂) | L(B₃) |

TABLE 2

| App | Asset | | | | | | | | | | | | | | | | | |
|---|---|---|---|---|---|---|---|---|---|---|---|---|---|---|---|---|---|---|
| Run | Use | | | | | | | | | | | | | | | | | |
| 1 | 1 | 2 | 3 | 4 | 5 | 6 | 7 | 8 | 9 | 10 | 11 | 12 | 13 | 14 | 15 | 16 | | |
| 2 | 1 | 2 | 3 | 4 | 5 | 6 | 7 | 8 | 9 | 12 | 13 | 14 | 15 | 16 | | | | |
| 3 | 1 | 2 | 3 | 4 | 5 | 16 | 7 | 8 | 9 | 10 | 11 | 12 | 13 | 14 | 15 | 7 | | |
| 4 | 1 | 2 | 3 | 4 | 5 | 6 | 7 | 8 | 9 | 10 | 11 | 17 | 18 | 19 | 20 | 21 | | |
| 5 | 1 | 2 | 3 | 4 | 5 | 6 | 7 | 8 | 22 | 10 | 11 | 12 | 13 | 14 | 15 | 16 | | |
| 6 | 1 | 2 | 3 | 4 | 5 | 6 | 7 | 8 | 9 | 22 | 11 | 12 | 13 | 14 | | | | |
| 7 | 1 | 2 | 3 | 4 | 5 | 6 | 7 | 8 | 22 | 10 | 11 | 12 | 13 | 14 | 15 | 16 | | |
| 8 | 1 | 2 | 3 | 4 | 5 | 6 | 7 | 8 | 22 | 10 | 11 | 17 | 18 | 19 | 20 | 21 | | |
| 9 | 1 | 2 | 3 | 4 | 5 | 6 | 7 | 8 | 22 | 10 | 11 | 12 | 13 | 14 | 13 | 14 | | |
| 10 | 1 | 2 | 3 | 4 | 5 | 6 | 7 | 8 | 22 | 10 | 11 | 12 | 17 | 18 | 15 | 16 | | |
| 11 | 1 | 2 | 3 | 4 | 5 | 6 | 7 | 8 | 22 | 10 | 11 | 12 | 13 | 14 | 15 | 16 | | |
| 12 | 1 | 2 | 3 | 4 | 5 | 6 | 7 | 8 | 22 | 10 | 11 | 12 | 13 | 14 | 15 | 16 | | |
| 13 | 1 | 2 | 3 | 4 | 6 | 7 | 8 | 9 | 10 | 11 | 12 | 13 | 14 | 15 | 16 | 17 | | |
| 14 | 1 | 2 | 3 | 4 | 5 | 6 | 7 | 8 | 9 | 10 | 11 | 12 | 13 | 14 | 15 | 16 | 17 | 18 |
| 15 | 1 | 2 | 3 | 4 | 5 | 6 | 7 | 8 | 22 | 10 | 11 | 12 | 13 | 14 | 15 | 16 | | |
| 16 | 1 | 2 | 3 | 4 | 5 | 6 | 7 | 8 | 9 | 10 | 11 | 17 | 18 | 14 | 15 | 16 | 12 | 13 |

TABLE 3

| Dependency | Probability | Probability | Probability |
|---|---|---|---|
| 1 | P(2\|1) = 16/16 | | |
| 2 | P(3\|2) = 16/16 | | |
| 3 | P(4\|3) = 16/16 | | |
| 4 | P(5\|4) = 15/16 | P(6\|4) = 1/16 | |
| 5 | P(6\|5) = 14/15 | P(16\|5) = 1/15 | |
| 6 | P(7\|6) = 15/15 | | |
| 7 | P(8\|7) = 16/16 | | |
| 8 | P(9\|8) = 8/16 | P(22\|8) = 8/16 | |
| 9 | P(10\|9) = 6/8 | P(12\|9) = 1/8 | P(22\|9) = 1/8 |
| 10 | P(11\|10) = 14/14 | | |
| 11 | P(12\|11) = 12/15 | P(17\|11) = 3/15 | |
| 12 | P(13\|12) = 13/14 | P(17\|12) = 1/14 | |
| 13 | P(14\|13) = 13/13 | | |
| 14 | P(13\|14) = 1/12 | P(15\|14) = 11/12 | |
| 15 | P(7\|15) = 1/12 | P(16\|15) = 11/12 | |
| 16 | P(7\|16) = 1/4 | P(12\|16) = 1/4 | P(17\|16) = 2/4 |
| 17 | P(18\|17) = 5/5 | | |
| 18 | P(14\|18) = 1/4 | P(15\|18) = 1/4 | P(19\|18) = 2/4 |
| 19 | P(20\|19) = 2/2 | | |
| 20 | P(21\|20) = 2/2 | | |
| 21 | | | |
| 22 | P(10\|22) = 8/9 | P(11\|22) = 1/9 | |

TABLE 4

| Loaded | Asset and | | Asset and | | Asset and | | Asset and | |
|---|---|---|---|---|---|---|---|---|
| Asset | Probability | | Probability | | Probability | | Probability | |
| 1 | 1 | 1.000 | | | | | | |
| 2 | 2 | 1.000 | | | | | | |
| 3 | 3 | 1.000 | | | | | | |
| 4 | 4 | 1.000 | | | | | | |
| 5 | 5 | 0.938 | 6 | 0.062 | | | | |
| 6 | 6 | 0.938 | 16 | 0.062 | | | | |
| 7 | 7 | 0.938 | 16 | 0.062 | | | | |
| 8 | 8 | 0.938 | 16 | 0.062 | | | | |
| 9 | 9 | 0.469 | 16 | 0.062 | 22 | 0.469 | | |
| 22 | 10 | 0.352 | 12 | 0.059 | 16 | 0.062 | 22 | 0.527 |
| 10 | 10 | 0.820 | 11 | 0.059 | 12 | 0.059 | 16 | 0.062 |
| 11 | 11 | 0.879 | 12 | 0.059 | 16 | 0.062 | | |
| 12 | 12 | 0.762 | 16 | 0.062 | 17 | 0.176 | | |
| 13 | 13 | 0.707 | 16 | 0.062 | 17 | 0.230 | | |
| 14 | 14 | 0.707 | 16 | 0.062 | 17 | 0.230 | | |
| 15 | 15 | 0.648 | 16 | 0.062 | 17 | 0.230 | | |
| 16 | 16 | 0.657 | 17 | 0.230 | | | | |
| 17 | 17 | 0.559 | | | | | | |
| 18 | 18 | 0.559 | | | | | | |
| 19 | 19 | 0.279 | | | | | | |
| 20 | 20 | 0.279 | | | | | | |
| 21 | 21 | 0.279 | | | | | | |

TABLE 5

| Loaded | Asset and | | Asset and | | Asset and | | Asset and | |
|---|---|---|---|---|---|---|---|---|
| Asset | Probability | | Probability | | Probability | | Probability | |
| 18 | 18 | 1.000 | | | | | | |
| 19 | 14 | 0.250 | 15 | 0.250 | 19 | 0.500 | | |
| 20 | 14 | 0.250 | 15 | 0.250 | 20 | 0.500 | | |
| 21 | 14 | 0.250 | 15 | 0.250 | 21 | 0.500 | | |
| 14 | 14 | 0.250 | 15 | 0.250 | | | | |
| 15 | 13 | 0.021 | 15 | 0.479 | | | | |
| 16 | 7 | 0.040 | 13 | 0.021 | 16 | 0.439 | | |
| 17 | 7 | 0.150 | 12 | 0.110 | 13 | 0.021 | 17 | 0.220 |
| 7 | 7 | 0.150 | 12 | 0.110 | 13 | 0.021 | | |
| 8 | 8 | 0.150 | 12 | 0.110 | 13 | 0.021 | | |
| 12 | 9 | 0.075 | 12 | 0.110 | 13 | 0.021 | 22 | 0.075 |
| 13 | 9 | 0.075 | 13 | 0.123 | 22 | 0.075 | | |
| 9 | 9 | 0.075 | 22 | 0.075 | | | | |
| 22 | 10 | 0.056 | 22 | 0.084 | | | | |
| 10 | 10 | 0.131 | 11 | 0.009 | | | | |
| 11 | 11 | 0.140 | | | | | | |

TABLE 6

| Loaded | Asset and | | Asset and | Asset and | Asset and |
|---|---|---|---|---|---|
| Asset | Probability | | Probability | Probability | Probability |
| 19 | 19 | 1.000 | | | |
| 20 | 20 | 1.000 | | | |
| 21 | 21 | 1.000 | | | |

TABLE 7

| Last | |
|---|---|
| Asset | Most Probable Asset Access Sequence |
| 1 | 1, 2, 3, 4, 5, 6, 7, 8, 9, 22, 10, 11, 12, 13, 14, 15, 16, 17, 18, 19, |
| | 20, 21 |
| 2 | 2, 3, 4, 5, 6, 7, 8, 9, 22, 10, 11, 12, 13, 14, 15, 16, 17, 18, 19, 20, |
| | 21 |
| 3 | 3, 4, 5, 6, 7, 8, 9, 22, 10, 11, 12, 13, 14, 15, 16, 17, 18, 19, 20, 21 |
| 4 | 4, 5, 6, 7, 8, 9, 22, 10, 11, 12, 13, 14, 15, 16, 17, 18, 19, 20, 21 |
| 5 | 5, 6, 7, 8, 9, 22, 10, 11, 12, 13, 14, 15, 16, 17, 18, 19, 20, 21 |
| 6 | 6, 7, 8, 9, 22, 10, 11, 12, 13, 14, 15, 16, 17, 18, 19, 20, 21 |
| 7 | 7, 8, 9, 22, 10, 11, 12, 13, 14, 15, 16, 17, 18, 19, 20, 21 |
| 8 | 8, 9, 22, 10, 11, 12, 13, 14, 15, 16, 17, 18, 19, 20, 21, 7 |
| 9 | 9.10, 11, 12, 13, 14, 15, 16, 17, 18, 19, 20, 21, 7, 8, 22 |
| 10 | 10, 11, 12, 13, 14, 15, 16, 17, 18, 19, 20, 21, 7, 8, 9, 22 |
| 11 | 11, 12, 13, 14, 15, 16, 17, 18, 19, 20, 21, 7, 8, 9, 22, 10 |
| 12 | 12, 13, 14, 15, 16, 17, 18, 7, 8, 19, 20, 21, 9, 22, 10, 11 |
| 13 | 13, 14, 15, 16, 17, 18, 7, 8, 12, 19, 20, 21, 9, 22, 10, 11 |
| 14 | 14, 15, 16, 17, 18, 7, 8, 12, 13, 19, 20, 21, 9, 22, 10, 11 |
| 15 | 15, 16, 17, 18, 7, 8, 12, 19, 20, 21, 13, 14, 9, 22, 10, 11 |
| 16 | 16, 17, 18, 7, 8, 12, 19, 20, 21, 13, 14, 15, 9, 22, 10, 11 |
| 17 | 17, 18, 19, 20, 21, 14, 15, 16, 7, 8, 12, 13, 9, 22, 10, 11 |
| 18 | 18, 19, 20, 21, 14, 15, 16, 17, 7, 8, 12, 13, 9, 22, 10, 11 |
| 19 | 19, 20, 21 |
| 20 | 20, 21 |
| 21 | 21 |
| 22 | 22, 10, 11, 12, 13, 14, 15, 16, 17, 18, 19, 20, 21, 7, 8, 9 |

LISTING 1

```
  1 #include <stdio.h>
  2 #include <string.h>
  3
  4 #define MAXASSET 23
  5 #define MAXRUN 32
  6 // Asset Usage
  7 int u[MAXRUN][MAXASSET];
  8 // Dependen2t usage
  9 int p1[MAXASSET][MAXASSET];
  10 // Total number of dependent uses
  11 int p[MAXASSET];
  12 // Dependent probability p1/p
  13 double fp1[MAXASSET][MAXASSET];
  14
  15 // Read asset load history data base
  16 int read_asset_use( );
  17 // Calculate dependent probability
  18 void calculate_probability(int);
  19 // Given the last asset loads calculate
  20 // the most probable future loads
  21 void load_order(int start);
  22 int verbose;
  23
  24 int main(int argc, char *argv[ ])
  25 {
  26  int l= 0;
  27  int start= 0;
  28  int n;
  29
  30  if(argc > 1) {
  31  // Calculate the asset load sequence from “start”
  32  start= atoi(argv[1]);
  33  }
  34  printf(“start=%d\n”, start);
  35
  36  n= read_asset_use( );
  37  calculate_probability(n);
  38
  39  if(start) {
  40  // If we have a start asset only calculate that asset
  41  verbose= 1;
  42  load_order(start);
  43  } else {
  44  for(l=1;l<MAXASSET;l++) {
  45  load_order(l);
  46  }
  47  }
  48 }
  49
  50 void calculate_probability(int n)
  51 {
  52  int l;
  53
  54  for(l=0;l<MAXASSET;l++) {
  55  int i;
  56  if(u[l][0] == 0)
  57  break;
  58  printf(“%3d: ”, l+1);
  59  for(i=0;i<n;i++) {
  60  if(u[l][i] == 0)
  61  break;
  62  printf(“%d,”, u[l][i]);
  63  if(i<(n−1) && u[l][i+1]) {
  64  p1[u[l][i]−1][u[l][i+1]−1]++;
  65  }some
  66  }
  67  printf(“\n”);
  68  }
  69  printf(“------------------\n”);
  70  for(l=0;l<MAXASSET;l++) {
  71  int i;
  72  printf(“%3d: ”, l+1);
  73  for(i=0;i<MAXASSET;i++) {
  74  printf(“%d,”, p1[l][i]);
  75  p[l]+= p1[l][i];
  76  }
  77  printf(“| %d\n”, p[l]);
  78  }
  79  for(l=0;l<MAXASSET;l++) {
  80  int i;
  81  printf(“%3d: ”, l+1);
  82  for(i=0;i<MAXASSET;i++) {
  83  if(p1[l][i]) {
  84  fp1[l][i]= ((double ) p1[l][i])/ p[l];
  85  printf(“P(%d|%d)=%d/%d(%3.3f),”, i+1, l+1,
  86  p1[l][i], p[l], fp1[l][i]);
  87  }
  88  }
  89  printf(“\n”);
  90  }
  91 }
  92
  93 void load_order(int start)
  94 {
  95  double ff[MAXASSET][MAXASSET];
  96  int a[MAXASSET];
  97  int loaded[MAXASSET];
  98  int l;
  99
100  memset(ff, 0, sizeof ff);
101  memset(a, 0, sizeof a);
102  memset(loaded, 0, sizeof loaded);
103  a[0]= start;
104  loaded[start−1]= 1;
105  ff[0][start−1]= 1.0;
106
107  for(l=0;l<MAXASSET−1;l++) {
108  int i;
109  double maxprop= 0.0;
110  int max= 0;
111  if(verbose)
112  printf(“%3d: ”, l+2);
113  for(i=0;i<MAXASSET;i++) {
114  ff[l+1][i]= (loaded[i] != 0) ? 0.0 :
115  ff[l][i] + fp1[a[l]−1][i]*ff[l][a[l]−1];
116  if(verbose) {
117  if(ff[l+1][i] != 0.0)
118  printf(“%d,%3.3f ”, i+1, ff[l+1][i]);
119  }
120  if(ff[l+1][i] > maxprop) {
121  maxprop= ff[l+1][i];
122  max=i;
123  }
124  }
125  if(maxprop > 0.0) {
126  if(verbose)
127  printf(“ a[%d]=%d”, l+1, max+1);
128  a[l+1]= max+1;
129  loaded[a[l+1]−1]= 1;
130  }
131  if(verbose)
132  printf(“\n”);
133  }
134  for(l=0;l<MAXASSET;l++) {
135  if(a[l] != 0)
136  printf(“%d,”, a[l]);
137  }
138  printf(“\n”);
139 }
140
```

What is claimed is:

1. A system for loading assets for the local thin client of a remote application determined by an analysis of previous application executions to reduce asset induced stalls and latency, comprising:
an executable program image designed to run a program on a local computing device;
an asset usage data base of previous executions;
a first computing device, comprising a first processor and running a first operating system, further comprising:
an application, running on the first processor, taken with modifications from said executable program image, said modifications comprising:
an extension stub for assembling the execution commands into a first data stream; and
a first transmitter for transmitting said first data stream assembled by said extension stub;
an asset loader, running on the first processor, for assembling a second data stream of predicted asset usage determined by the asset usage of previous executions in conjunction with the current asset usage of said running application; and
a second transmitter for transmitting said second data stream;
a second computing device, comprising a second processor and running a second operating system, further comprising:
a receiver for receiving the first and second data streams from said first computing device; and
a thin client, running on the second processor, for disassembling the two data streams, executing the disassembled commands and caching the loaded assets;
a communications channel for coupling said first and second transmitters of said first computing device to said receiver of said second computing device.

2. The system of claim 1 wherein said asset loader, loads all assets before said thin client begins execution of the disassembled commands.

3. The system of claim 1 wherein said asset loader, determines the predicted asset usage by the asset usage of one execution of the application in conjunction with the current asset usage of said running application.

4. The system of claim 1 wherein said asset loader, determines the predicted asset usage by the asset usage of the most recent completed execution of the application in conjunction with the current asset usage of said running application.

5. The system of claim 1 wherein said asset loader, determines the predicted asset usage by the conditional probabilities of asset usage computed from the asset usage of previous executions in conjunction with the current asset usage of said running application.

6. The system of claim 1 wherein:
said executable program image is an executable program image designed to run a graphical program on a local computing device;
said extension stub assembles graphical rendering commands into a first data stream; and
said thin client executes the disassembled graphical rendering commands.

7. The system of claim 6 wherein the graphical rendering commands are SKIA rendering commands.

8. The system of claim 6 wherein the graphical rendering commands are OpenGL rendering commands.

9. The system of claim 6 wherein the graphical rendering commands are Android Canvas.cpp rendering commands.

10. The system of claim 6 wherein the graphical rendering commands are Android OpenGLRenderer.cpp rendering commands.

11. A method for loading assets for the local thin client of a remote application determined by an analysis of previous application executions to reduce asset induced stalls and latency, comprising:
providing an executable program image of an application designed to run on a local computing device;
supplying an asset usage data base of previous executions;
modifying the executable program image of the application, to obtain a modified executable image of the application with the additional capabilities of:
assembling the execution commands into a data stream; and
transmitting the data stream to a separate distinct computing device;
running, on a first computing device, the modified executable program image of the application;
assembling, on the first computing device, by the modified executable program image of the program image, the execution commands into a first data stream;
transmitting, on the first computing device, by the modified executable program image of the application, the first data stream to a second computing device;
running, on the first computing device, an asset loader to generate a second data stream of predicted asset usage determined by the asset usage of previous executions in conjunction with the current asset usage of said running application;
transmitting, on the first computing device, by the asset loader, the second data stream to a second computing device;
receiving, on the second computer device, the first and second data streams;
disassembling, on the second computing device, the received data streams into a plurality of executing commands and assets;
caching, on the second computing device, the received assets; and
executing, on the second computing device, the disassembled execution commands.
